(19) United States
(12) Patent Application Publication
(10) Pub. No.: US 2025/0371006 A1
(43) Pub. Date: Dec. 4, 2025

(54) System and Method for Enhancing Generative Artificial Intelligence (AI) Model-based Matching of Queries and Contents with Semantically Overlapping Chunks

(71) Applicant: Dell Products L.P., Round Rock, TX (US)

(72) Inventors: Shaul Dar, Petach Tikva (IL); Ramakanth Kanagovi, Hyderabad (IN); Guhesh Swaminathan, Chennai (IN); Rajan Kumar, Nawada (IN); Ophir Jehoshua Buchman, Ra'anana (IL)

(21) Appl. No.: 18/732,357

(22) Filed: Jun. 3, 2024

(51) Int. Cl. G06F 16/2453

(52) U.S. Cl. CPC G06F 16/24542

(57) ABSTRACT

A method, computer program product, and computing system for generating a plurality of chunks for a plurality of text portions of a document. A plurality of chunk embeddings are generated from the plurality of chunks. A query is processed using a generative artificial intelligence (AI) model. A query embedding is generated from the query. A plurality of candidate chunks are identified from the plurality of chunks based upon, at least in part, a similarity between the plurality of chunk embeddings and the query embedding. An amount non-overlapping content of each candidate chunk is determined relative to each other candidate chunk. A subset of the plurality of candidate chunks are selected for inclusion in a prompt with the query based upon, at least in part, the amount of non-overlapping content of each candidate chunk.

### BACKGROUND

Generative artificial intelligence (AI) models, such as Large Language Model (LLMs)s have recently proven to be a better alternative to traditional search engines, helping users find pieces of information they are looking for, and able to provide more concise and relevant answers, albeit with a risk that the answers may be irrelevant or incorrect.

In some instances, the query that a user types is given as input to the LLM, along an appropriate context, which is the text that the LLM should “search” for in an answer, a technique that is called prompt engineering. The main problem with this approach is that the size of the prompt is limited. For example, the limit for GPT3.5-Turbo is 4,096 tokens, the limit for GPT4 is 8,192 tokens, and the limit for GPT-4-32k is 32,768 tokens. Documents or other content that can be searched using the LLM are often orders of magnitude larger than the prompt size limit. For example, the size of a single example storage system user guide is twenty megabytes, and the size of the complete set of relevant installation documents and knowledge base articles ranges between hundreds of megabytes to hundreds of gigabytes. Accordingly, Retrieval Augmented Generation (RAG) is used to break input documents into chunks that are small enough to fit the prompt size limitations. It then uses common indexing and retrieval techniques to match user queries to the most relevant content chunks, and then combines the user query and context (one or more chunks) as a prompt to the LLM and presents the answers to the user.

Conventional approaches chunk input documents successively, taking each time as many characters as possible without exceeding the prompt size limitations. This approach seeks to find the best answer for a given query, based on a single chunk (i.e., the one best matching the query). However, this does not address the case when there are multiple potential answers for a query, originating from different text chunks and, possibly, from different documents. For example, such approaches may result in redundant information being presented to the user, while important relevant information is omitted because of prompt size limitations.

### SUMMARY OF DISCLOSURE

In one example implementation, a computer-implemented method executed on a computing device may include, but is not limited to, generating a plurality of chunks for a plurality of text portions of a document. A plurality of chunk embeddings are generated from the plurality of chunks. A query is processed using a generative artificial intelligence (AI) model. A query embedding is generated from the query. A plurality of candidate chunks are identified from the plurality of chunks based upon, at least in part, a similarity between the plurality of chunk embeddings and the query embedding. An amount non-overlapping content of each candidate chunk is determined relative to each other candidate chunk. A subset of the plurality of candidate chunks are selected for inclusion in a prompt with the query based upon, at least in part, the amount of non-overlapping content of each candidate chunk.

One or more of the following example features may be included. Processing the query may include processing the query during Retrieval Augmented Generation (RAG) using the generative AI model. Determining the amount of non-overlapping content of each candidate chunk may include determining a cosine-similarity between each candidate chunk relative to each other candidate chunk. Determining the amount of non-overlapping content of each candidate chunk may include determining a token sort ratio between tokens of each candidate chunk relative to each other candidate chunk. Determining the amount of non-overlapping content of each candidate chunk may include determining a token set ratio between tokens of each candidate chunk relative to each other candidate chunk. Selecting the subset of the plurality of candidate chunks for inclusion in the prompt may include selecting a first candidate chunk with a highest similarity value compared to the query; and selecting an additional candidate chunk with a highest amount of non-overlapping content relative to remaining candidate chunks of the plurality of chunks. The prompt may be generated using the query and the subset of the plurality of candidate chunks. The prompt may be provided to the generative AI model.

In another example implementation, a computer program product resides on a computer readable medium that has a plurality of instructions stored on it. When executed by a processor, the instructions cause the processor to perform operations that may include, but are not limited to, generating a plurality of chunks for a plurality of text portions of a document. A plurality of chunk embeddings are generated from the plurality of chunks. A query is processed using a generative artificial intelligence (AI) model. A query embedding is generated from the query. A plurality of candidate chunks are identified from the plurality of chunks based upon, at least in part, a similarity between the plurality of chunk embeddings and the query embedding. An amount non-overlapping content of each candidate chunk is determined relative to each other candidate chunk. A subset of the plurality of candidate chunks are selected for inclusion in a prompt with the query based upon, at least in part, the amount of non-overlapping content of each candidate chunk.

One or more of the following example features may be included. Processing the query may include processing the query during Retrieval Augmented Generation (RAG) using the generative AI model. Determining the amount of non-overlapping content of each candidate chunk may include determining a cosine-similarity between each candidate chunk relative to each other candidate chunk. Determining the amount of non-overlapping content of each candidate chunk may include determining a token sort ratio between tokens of each candidate chunk relative to each other candidate chunk. Determining the amount of non-overlapping content of each candidate chunk may include determining a token set ratio between tokens of each candidate chunk relative to each other candidate chunk. Selecting the subset of the plurality of candidate chunks for inclusion in the prompt may include selecting a first candidate chunk with a highest similarity value compared to the query; and selecting an additional candidate chunk with a highest amount of non-overlapping content relative to remaining candidate chunks of the plurality of chunks. The prompt may be generated using the query and the subset of the plurality of candidate chunks. The prompt may be provided to the generative AI model.

In another example implementation, a computing system includes at least one processor and at least one memory architecture coupled with the at least one processor, wherein the at least one processor is configured to generate a plurality of chunks for a plurality of text portions of a document. A plurality of chunk embeddings are generated from the plurality of chunks. A query is processed using a generative artificial intelligence (AI) model. A query embedding is generated from the query. A plurality of candidate chunks are identified from the plurality of chunks based upon, at least in part, a similarity between the plurality of chunk embeddings and the query embedding. An amount non-overlapping content of each candidate chunk is determined relative to each other candidate chunk. A subset of the plurality of candidate chunks are selected for inclusion in a prompt with the query based upon, at least in part, the amount of non-overlapping content of each candidate chunk.

One or more of the following example features may be included. Processing the query may include processing the query during Retrieval Augmented Generation (RAG) using the generative AI model. Determining the amount of non-overlapping content of each candidate chunk may include determining a cosine-similarity between each candidate chunk relative to each other candidate chunk. Determining the amount of non-overlapping content of each candidate chunk may include determining a token sort ratio between tokens of each candidate chunk relative to each other candidate chunk. Determining the amount of non-overlapping content of each candidate chunk may include determining a token set ratio between tokens of each candidate chunk relative to each other candidate chunk. Selecting the subset of the plurality of candidate chunks for inclusion in the prompt may include selecting a first candidate chunk with a highest similarity value compared to the query; and selecting an additional candidate chunk with a highest amount of non-overlapping content relative to remaining candidate chunks of the plurality of chunks. The prompt may be generated using the query and the subset of the plurality of candidate chunks. The prompt may be provided to the generative AI model.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and an overlapping content selection process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of overlapping content selection process according to one or more example implementations of the disclosure;

FIG. 4 is an example diagrammatic view of a retrieval augmented generation (RAG) process according to one or more example implementations of the disclosure; and

FIG. 5 is an example diagrammatic view of the semantic overlapping of chunks according to various example implementations of the disclosure.

Like reference symbols in the various drawings indicate like elements.

### DETAILED DESCRIPTION

### System Overview:

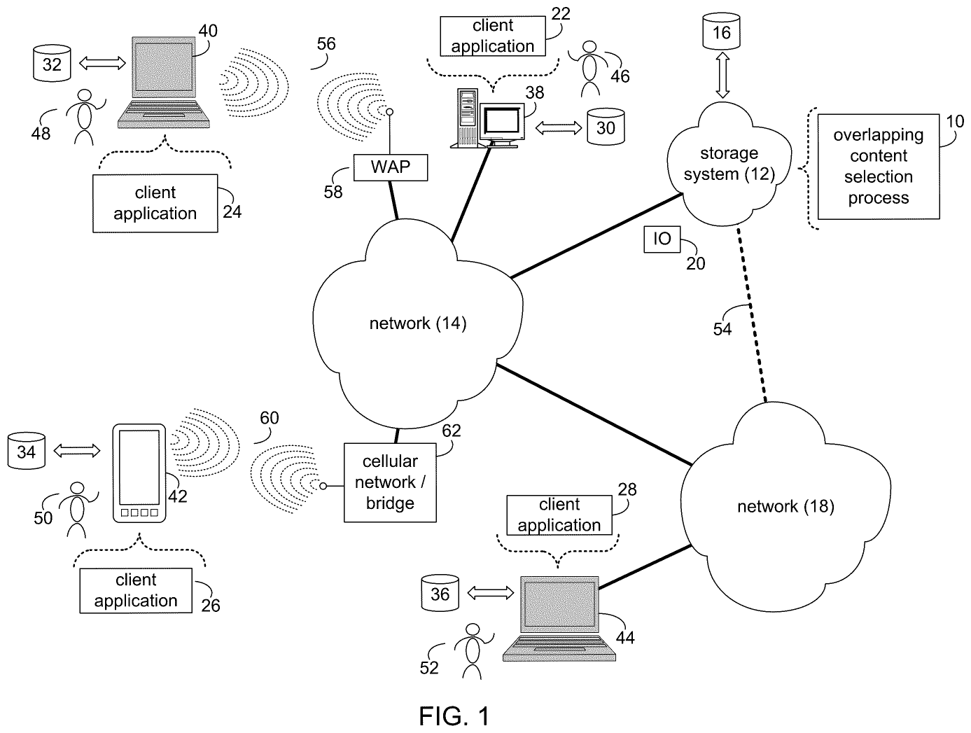

Referring to FIG. 1, there is shown overlapping content selection process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device, and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries, or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of overlapping content selection process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of overlapping content selection process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries, or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an overlapping content selection process, such as overlapping content selection process 10 of FIG. 1, may include but is not limited to, generating a plurality of chunks for a plurality of text portions of a document. A plurality of chunk embeddings are generated from the plurality of chunks. A query is processed using a generative artificial intelligence (AI) model. A query embedding is generated from the query. A plurality of candidate chunks are identified from the plurality of chunks based upon, at least in part, a similarity between the plurality of chunk embeddings and the query embedding. An amount non-overlapping content of each candidate chunk is determined relative to each other candidate chunk. A subset of the plurality of candidate chunks are selected for inclusion in a prompt with the query based upon, at least in part, the amount of non-overlapping content of each candidate chunk.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System:

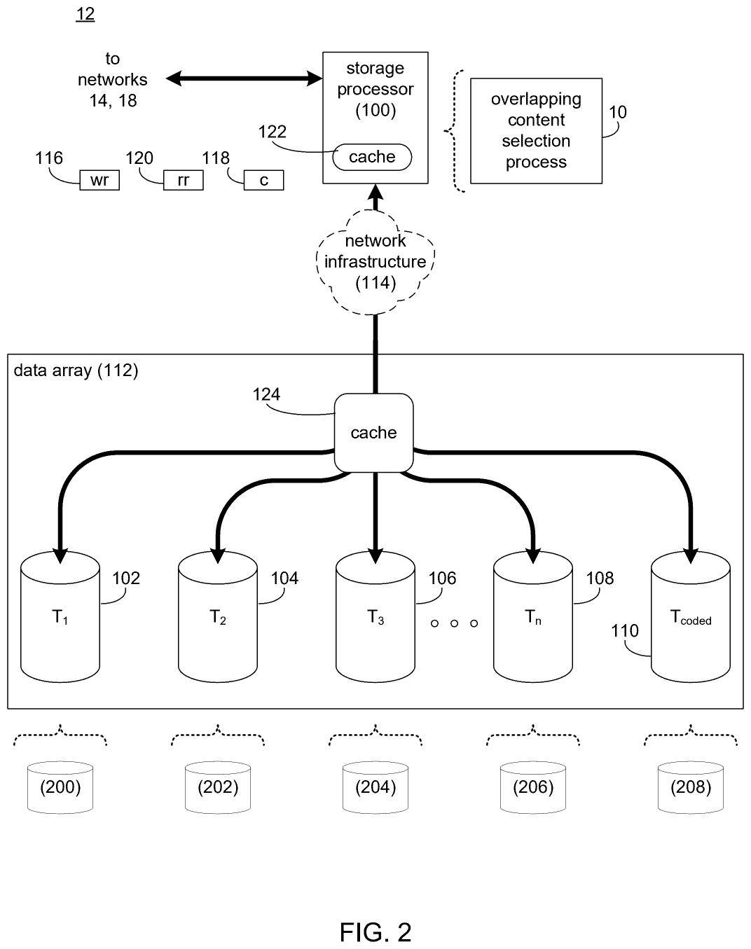

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of overlapping content selection process 10. The instruction sets and subroutines of overlapping content selection process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of overlapping content selection process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of overlapping content selection process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of overlapping content selection process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

### The Overlapping Content Selection Process:

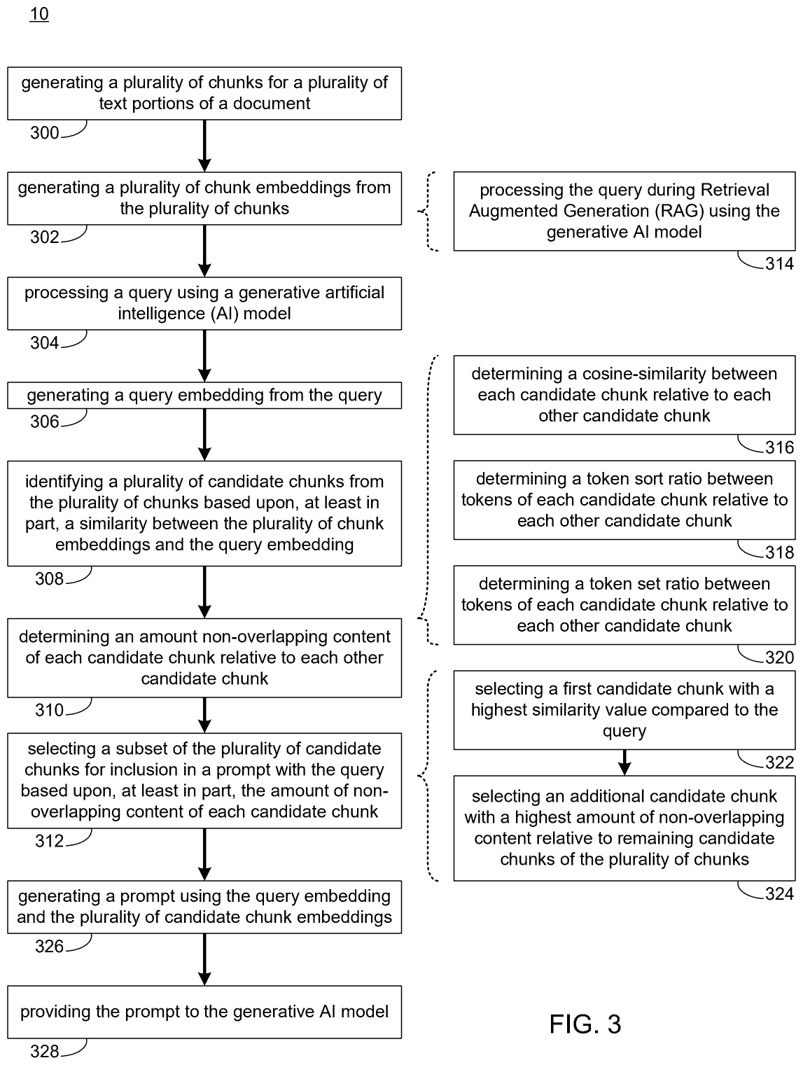

Referring also to the examples of FIGS. 3-5 and in some implementations, overlapping content selection process 10 may generate 300 a plurality of chunks for a plurality of text portions of a document. A plurality of chunk embeddings are generated 302 from the plurality of chunks. A query is processed 304 using a generative artificial intelligence (AI) model. A query embedding is generated 306 from the query. A plurality of candidate chunks are identified 308 from the plurality of chunks based upon, at least in part, a similarity between the plurality of chunk embeddings and the query embedding. An amount non-overlapping content of each candidate chunk is determined 310 relative to each other candidate chunk. A subset of the plurality of candidate chunks are selected 312 for inclusion in a prompt with the query based upon, at least in part, the amount of non-overlapping content of each candidate chunk.

As will be discussed in greater detail below, implementations of the present disclosure may allow for the selection of chunks for inclusion in a prompt using semantic overlap between a set of candidate chunks. Accordingly, overlapping content selection process 10 may define and calculate unique chunk values when candidate chunks are semantically overlapping. Using the unique (i.e., disjoint, non-overlapping) chunk contributions, overlapping content selection process 10 selects the optimal set of chunks to provide to the LLM.

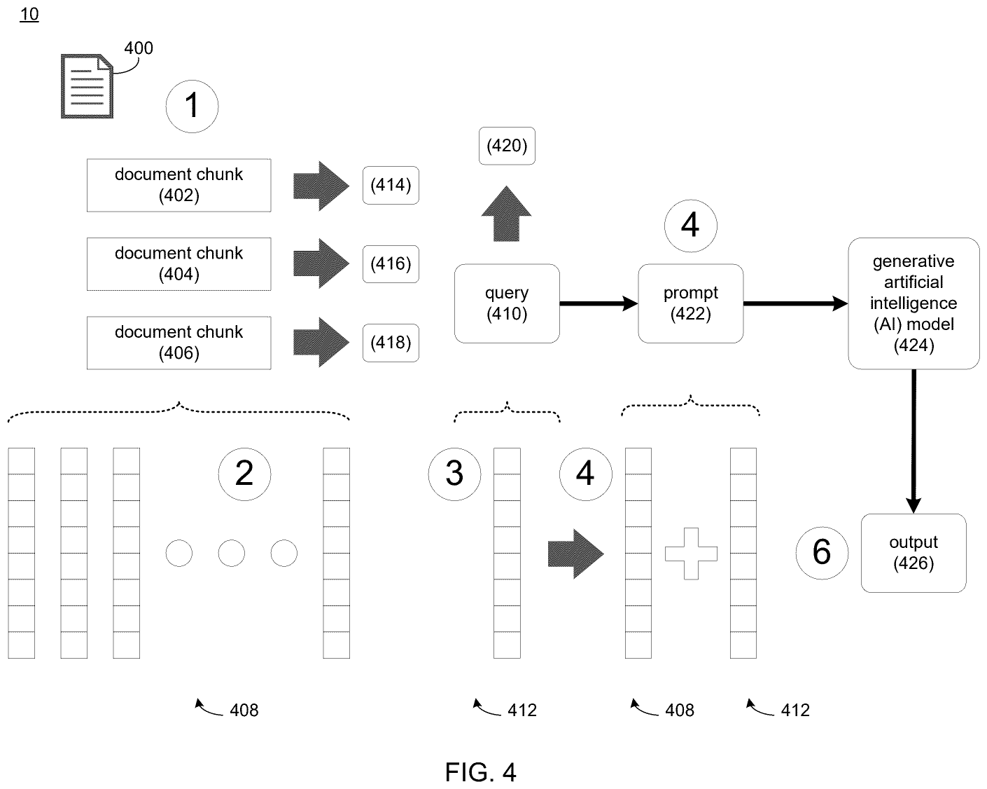

Referring to the example document shown in FIG. 4, consider a user guide titled “Dell PowerStore Protecting Your Data” (e.g., document 400) and a user query “What is the difference between snapshots and replication?”. There are multiple overlapping candidate chunks in the source document matching this query. For example and as will be discussed in greater detail below, document 400 may include the following five portions or chunks:
Chunk 1
   Snapshot rules:
      You can create snapshot rules to control parameters such as the frequency of snapshot creation, and snapshots retention period. You can also create snapshot rules for generating secure snapshots. Snapshot rules, together with replication rules and remote backup rules enable you to configure and apply consistent data protection policies to storage resources based on the data protection requirements.
      If you want to create a snapshot rule in addition to the existing rules, it is recommended to review the business requirements with an administrator before proceeding. This can help in achieving and maintaining consistent policies across the system.
   Create a snapshot rule:
      Steps
         1. Select Protection>Protection Policies.
         2. In the Protection Policies window, click Snapshot Rules on the Protection bar.
         3. In the Snapshot Rules window, click Create.
         4. In the Create Snapshot Rule slide-out panel, enter a name for the new rule.
         5. Set the following:
         Select the days on which a snapshot will be created.
         Set the frequency/start time:
         For a snapshot to be taken at a fixed interval, select this option and set the number of hours after which a snapshot will be created.
         For a snapshot to be taken at a particular time of the selected days, select the Time-of-day option and set the time and time zone.
         Set the retention period.
         To create secure snapshots, select the Secure Snapshot option. For details on secure snapshots, see Secure snapshots. NOTE: It is recommended to review the business requirements with an administrator before proceeding, to avoid reaching the maximum snapshot limit. For file snapshots, select the file snapshot access type.
         6. Click Create.
Chunk 2
   Snapshots:
      Snapshots are read-only, point-in-time copies of data of a volume, volume group, virtual machine, or file system. Creating a snapshot saves the state of the storage resource at that particular point-in-time. Using snapshots, you can protect your data locally and restore a storage resource to a previous state.
      You can manually create snapshots at any time. It is also possible to configure snapshot rules as part of a protection policy and assign them to the relevant storage resources. The system automatically creates snapshots of the relevant resource according to the schedule specified in the protection policy.
      As of PowerStore 3.5, you can create secure snapshots that cannot be manually deleted by an administrator or an intruder and are automatically deleted only when they reach their expiration time. Secure snapshots provide an additional means of protection from ransomware attacks.
      If data corruption occurs or data is accidentally deleted, you can recover the data from the snapshots or restore the volume or volume group to the point in time when the snapshot was created.
      For file systems, you can create two access types of read-only file snapshot: protocol and. snapshot. The default access type is protocol, which can be exported as an SMB share, NFS export, or both. You can share and mount the snapshot on a client like any other file system. For .snapshot access types, you can access the files within the snapshot from the production file system in the .snapshot subdirectory of each directory.
      You can also create write-order consistent and application consistent snapshots of volumes:
         Write-order consistent snapshots—PowerStore holds all writes on the volume group members to provide a uniform point-in-time copy and ensures consistent protection across all member volumes. You can generate write-order consistent snapshots from the PowerStore Manager.
         Application consistent snapshots—You can create application consistent snapshots of a volume or a volume group using AppSync. When you create an application consistent snapshot, all incoming I/O for a given application is quiesced while the snapshot is created.
      To verify whether a snapshot is write-order consistent or application consistent, look at the Write-Order Consistent and Application Consistent columns in the snapshot tables for a volume or volume group in PowerStore Manager.
      NOTE: If you cannot see these columns, you can add them, using the Show/Hide Table Columns option. Mapping snapshots to hosts is not supported in PowerStore. To allow a connected host to access a snapshot, you can create a thin clone—a writable, space efficient copy of the snapshot—and map it to a host. You can update the thin clone from different snapshots using the refresh operation. For details on the possible snapshot-related operations you can perform, using the PowerStore Manager, see the Snapshots chapter.
Chunk 3
   Using clones to access read-only snapshots from hosts:
      Mapping and unmapping block snapshots to hosts is not supported in PowerStore. To allow a connected host to access a snapshot, create a thin clone of the snapshot and map it to a host. After creating the thin clone, you can use the refresh operation to update the thin clone from different snapshots. For more information, see Refresh a storage resource.
      File snapshots can be mounted on hosts either directly (to allow read-only access) or by creating a thin clone (to allow read-write access). To mount the file system directly, the snapshots can be exported as NFS export or SMB share.
      You can export snapshots using one of the following access types:
         Protocol—The snapshot is exported with a new share name.
         Snapshot—You can see the snapshot on Unix/Linux under the .snapshot directory of the file system, and on Windows, by right-clicking the file system and selecting the Previous Version option.
Chunk 4
   Use cases:
   This chapter contains the following information:
   Topics:
      Snapshot and thin clone use cases
      Replication use cases
      Metro protection use cases.
   Snapshot and thin clone use cases:
      You can use snapshots and thin clones to restore corrupted volumes and create test environments.
      Snapshots are read-only copies that can be used to save the current state of an object. You can use snapshots to quickly recover data if there is corruption or user error. Snapshots cannot be directly accessed by a host.
      Thin clones are writable copies of a snapshot, volume, or volume group that can be accessed by a host. Thin clones can be created directly as a copy of the parent object or using one of its snapshots. Both snapshots and thin clones are space efficient copies that share data blocks with their parent object.
   . . .
   Metro protection use cases:
      Use Metro protection to ensure data high availability, load balancing and migration.
   Using metro for high availability:
      A Metro volume is exposed using two distinct storage arrays that cooperate to expose a single Metro volume to application hosts by providing the same SCSI image and data. The hosts and applications running on them perceive two physical volumes as a single volume with multiple paths. As a result, hosts can access both sides of the Metro volume. If there is a link loss or failure of one of the systems, host access can still be maintained to the active system.
      Metro protection provides bi-directional synchronous replication, where both sides of the Metro volume can be used for production. Instead of disaster recovery (by failing over a replication session to a remote system), Metro enables disaster avoidance by providing automatic synchronization between the systems without downtime.
   Using metro for load balancing:
      With PowerStore metro volume, the data centers can be optimized to fully use PowerStore systems through an active/active environment that enables workload balancing across PowerStore systems. Moving applications non-disruptively between PowerStore systems is simple and easy and can be done when capacity or performance balancing is required.
   Using metro for migration:
      You can use metro volumes when there is a need to migrate workloads between PowerStore systems. Using metro volumes for migration is simple and easy to use, and it reduces the risk for data loss. With the metro volume option, the migration is non-disruptive and, when migration is complete, the metro volume can be either removed or kept for allowing an extremely fast recovery in the event of a system failure or even a full site failure.
Chunk 5
Synchronization:
   PowerStore enables you to asynchronously update the destination resource with changes (such as changes in content, size, and membership) that occurred on the source resource since the last synchronization cycle.
   Synchronization can occur either automatically—according to a set schedule—or manually. Snapshots are synchronized from the source system to the destination system and maintain block sharing efficiency.
   NOTE: Virtual volume synchronization is supported only for Read-Only snapshots.
   When a volume on the destination system is mapped to a host, the system sets the node affinity for this volume, and as a result, all I/Os are automatically directed to the selected node. You do not need to pause and resume the replication session for the I/O redirection to take effect. Setting node affinity for volumes on the destination system provides load balancing and prevents latency of replication. You can set the node affinity manually using REST API.
   NOTE: If you cannot see the node affinity column in the Volumes table, add it using the Show/Hide Table Columns.
   NOTE: When you add volumes to a volume group or change the size of the volume group during an asynchronous replication session, the changes do not immediately appear on the destination. You can either perform a manual synchronization or wait until the synchronization occurs based on the RPO.
   For NAS servers, all file systems on a protected NAS server are synchronized from the source to destination system. When file systems are modified during an asynchronous replication session, the changes are reflected on the destination system at the next synchronization cycle.
   You can synchronize a replication session when it is in the following states:
      Operating normally
      System paused
   While a replication session is synchronizing, you can take the following actions:
      Perform a planned failover from the source system.
      Perform a failover from the destination system.
      Pause replication sessions from the source or destination system.
      Delete a replication session by removing a protection policy.
   If synchronization fails, the replication session is placed in a system paused state. When the system recovers, the replication session continues from the same point as when the system was paused.

In this example, other RAG techniques may select chunks for inclusion based on the cosine similarity of each chunk with the above query. In these examples and as shown in Table 1 below, chunks 1, 2 and 3 may be selected (in that order).

TABLE 1

| | Chunk | Chunk | Chunk | Chunk | Chunk |
|---|---|---|---|---|---|
| | 1 | 2 | 3 | 4 | 5 |
| Cosine Similarity | .845 | .843 | .829 | .827 | .826 |
| wrt. Query | | | | | |
| Cosine Similarity | 1 | .88 | .851 | .823 | .868 |
| (Chunk 1, chunk K) | | | | | |
| Token sort ratio | 1 | .58 | .53 | .29 | .54 |
| (Chunk1, Chunk K) | | | | | |

However, this an optimal set of answers with the implicit assumption that the candidate chunks are disjoint. In this example, the chunks are not disjoint. In particular and as shown in Table 1, there is high similarity between Chunk 1 (the chunk best matching the query and hence logical top answer), and Chunks 2, followed by Chunk 5. This is manifested in a cosine similarity score of 0.88 and 0.868 for Chunk 2 and Chunk 5 respectively, and token sort similarity scores of 0.58 and 0.54 for Chunk 2 and Chunk 5 respectively (with respect to Chunk 1). Cosine similarity provides a high-level indication of text overlap, since the vector embeddings it relies on are averaged across all the tokens in the relevant chunk, while token sort similarity is a much more accurate metric.

Accordingly, implementations of the present disclosure determine the unique or disjoint contribution of each chunk relative to a given query, and use that to select an optimal, ordered, set of chunks to include in the context provided to the LLM, from which the answer presented to the user will be derived. As shown in FIG. 4, a document (e.g., document 400) may include a plurality of text portions that may provide a basis for answering a user query.

In some implementations, overlapping content selection process 10 provides a plurality of respective chunks for use during retrieval augmented generation (RAG). As shown in FIG. 4 and when preparing an input document for retrieval augmented generation (RAG), overlapping content selection process 10 processes a collection of input documents (e.g., document 400) and breaking each input document into chunks (e.g., document chunks 402, 404, 406). This is shown as action “1”.

In some implementations, overlapping content selection process 10 generates 300 a plurality of chunks for a plurality of text portions of a document. For example and referring again to FIG. 4, a document (e.g., document 400) includes text portions. In some implementations, overlapping content selection process 10 generates a plurality of chunks from the plurality of text portions of document 400. A chunk is a discrete portion of the document that is used to generate a word embedding for combination with a query embedding to provide content in a prompt provided to a generative AI model during RAG. Generating 300 the plurality of chunks includes generating an index or indexes for searching during query processing. As such, each generated chunk may be stored in a database or other data structure as an index. In this example, overlapping content selection process 10 generates 300 chunk 402 for a first text portion; chunk 404 for a second text portion; and chunk 406 for a third text portion. While an example of a single document (e.g., document 400) is described, it will be appreciated that overlapping content selection process 10 may generate a plurality of chunks for a plurality of documents within the scope of the present disclosure.

In some implementations, overlapping content selection process 10 generates 302 a plurality of chunk embeddings from the plurality of chunks. For example, overlapping content selection process 10 indexes each chunk using a word embedding. Referring again to FIG. 4, overlapping content selection process 10 generates 300 a plurality of chunks as described above (e.g., document chunks 402, 404, 406) from document 400. Accordingly, overlapping content selection process 10 indexes the plurality of respective chunks (e.g., document chunks 402, 404, 406) into a plurality of word embeddings (e.g., word embeddings 408) by converting each document chunk into a vector of embeddings. In some implementations, indexing each chunk into a word embedding includes passing each chunk of content (i.e., text) through a transformer, and a vector of numbers corresponding to the dimensions for the vector embedding is outputted. The resulting content chunks and their vector embeddings (e.g., word embeddings 408) are stored in a database. This is shown as action “3”.

In some implementations, overlapping content selection process 10 processes 304 a query using a generative artificial intelligence (AI) model. As discussed above, a query (e.g., query 410) is a request from a user for information from a document or a plurality of documents. In one example, query 410 may include a text string in the form of a request or a question. In another example, query 410 may be initially received as a recorded audio request from a user that is converted into a machine-readable version of the audio signal and/or converted to text (e.g., using an automated speech recognition system). In some implementations, overlapping content selection process 10 processes 304 the query during Retrieval Augmented Generation (RAG) using the generative AI model. For example and as discussed above, RAG is a process used to break relevant input documents into chunks that are small enough to fit prompt size limitations associated with a generative AI model for processing queries upon.

In some implementations, overlapping content selection process 10 generates 306 a query embedding from the query. For example, given a user query (e.g., query 410), the query text is transformed into a vector of embeddings (e.g., query embedding 412) by passing each query 410 through a transformer to generate a vector of numbers corresponding to the dimensions for the vector embedding (e.g., query embedding 412). The transformer may include any language model or word embedding model that converts text into a numerical representation. In some implementations, query embedding 412 is a numerical representation of the semantic meaning of query 410 and allows query 410 to be understood and processed more effectively when comparing against chunk embeddings of document 400. This is shown as action “4”.

In some implementations, overlapping content selection process 10 may identify 308 a plurality of candidate chunks from the plurality of chunks based upon, at least in part, a similarity between the plurality of chunk embeddings and the query embedding. In some implementations, identifying 308 the plurality of candidate chunk embeddings includes determining a chunk similarity score associated with each chunk. A chunk similarity score is a numerical representation of the similarity between a chunk embedding and a query embedding. For example, overlapping content selection process 10 determines or generates a chunk similarity score to each candidate chunk based on of how well it matches a given query. The score is based on the similarity, or distance, between the vector embeddings of the chunk and query. It will be appreciated that any distance metric can be used within the scope of the present disclosure. In one example, overlapping content selection process 10 determines the chunk similarity score using cosine similarity. Cosine similarity scoring assigns a score in the range of [−1,1], where a score close to “1” means the two vectors are similar (codirectional), a score close to “−1” means the two vectors are opposite, and a score close to “0” means the two vectors are unrelated (orthogonal). In some implementations, overlapping content selection process 10 limits the score to the range of [0,1] and ignore chunks that have a negative cosine similarity with the query.

In some implementations, overlapping content selection process 10 determines the chunk similarity score (e.g., chunk similarity scores 414, 416, 418) by comparing chunks 402, 404, 406 to query 410 as a value between “0” and “1” where the closer the score is to “1”, the greater the similarity between the given chunk embedding and query embedding 510 and the closer the score is to “0”, the lower the similarity between the given chunk embedding and query embedding 412.

In some implementations, overlapping content selection process 10 determines a threshold number of most similar chunks based on the similarity between the plurality of chunk embeddings and the query embedding. In one example, the threshold number is a predefined value (e.g., ten candidate chunks). In another example, the threshold number is a user-defined number of chunks. However, it will be appreciated that the threshold may be obtained or determined from various sources within the scope of the present disclosure.

In some implementations, overlapping content selection process 10 may determine 310 an amount non-overlapping content of each candidate chunk relative to each other candidate chunk. Non-overlapping content includes content (i.e., words, phrases, concepts) that are semantically unique to each chunk. In this manner, the non-overlapping content is not semantically covered by other chunks in the plurality of candidate chunks, where semantic coverage is a function of the words and phrases of each chunk.

In some implementations, determining 310 the amount of non-overlapping content of each candidate chunk includes determining 316 a cosine-similarity between each candidate chunk relative to each other candidate chunk. For example, overlapping content selection process 10 determines 316 the cosine-similarity of textual overlap by assigning a score in the range of [−1,1], where a score close to “1” means the two vectors are similar (codirectional), a score close to “−1” means the two vectors are opposite, and a score close to “0” means the two vectors are unrelated (orthogonal). In some implementations, overlapping content selection process 10 limits the score to the range of [0,1] and ignore chunks that have a negative cosine similarity with the query. This approach provides a fast but generally approximate estimate of semantic overlap, since the vector embeddings it relies on are averaged across all the tokens in the relevant chunks.

In some implementations, determining 310 the amount of non-overlapping content of each candidate chunk includes determining 318 a token sort ratio between tokens of each candidate chunk relative to each other candidate chunk. A token sort ratio is a similarity measure that includes tokenizing strings of each chunk into individual words, sorts them alphabetically, and then calculates the similarity ratio between them. This approach may generally be insensitive to word order in each chunk and is effective for chunks with different word orders while including the same words.

In some implementations, determining 310 the amount of non-overlapping content of each candidate chunk includes determining 320 a token set ratio between tokens of each candidate chunk relative to each other candidate chunk. A token set ratio is a similarity measure that includes tokenizing strings of each chunk into individual words, disregarding duplicates, and then calculating the similarity ratio. It is also insensitive to word order. In some implementations, overlapping content selection process 10 determines a partial token set ratio by tokenizing both strings, ignoring duplicates, and identifying the best matching subset within the longer string.

In some implementations, overlapping content selection process 10 determines 308 the amount of non-overlapping content of a respective (e.g., chunk 2) with respect to another chunk (e.g., chunk 1) as shown below in Equation 1:

Amount of non-overlapping content=(1−sims_score(chunk1, chunk2))*chunk2_value, where “sims_score” is the similarity score between respective chunks. (1)

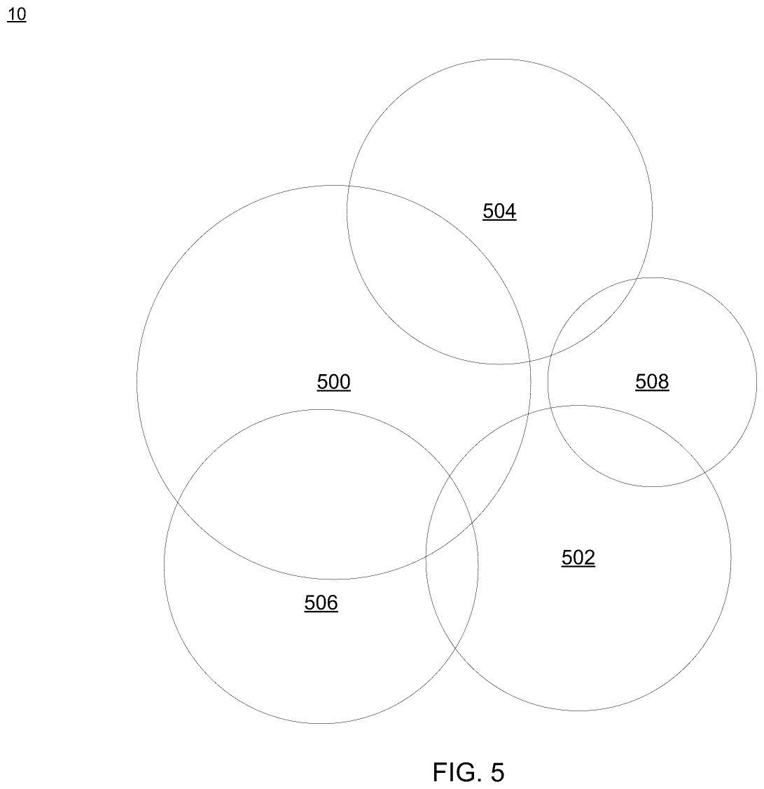

Referring also to FIG. 5, each chunk (e.g., chunks 500, 502, 504, 506, 508) is represented as a separate circle where the overlapping content of each chunk relative to the other chunks is shown by the overlapping of each circle.

In some implementations, while performing string comparisons on multiple chunks may appear to be computationally expensive, in practice, the required computation cost is neglible and measured is in milliseconds, in comparison to the computation and time required by the LLM to generate an answer (i.e., decoding), typically measured in seconds. In another example, overlapping content selection process 10 caches chunk overlap scores, using e.g. 4 bits per each pair.

In some implementations, overlapping content selection process 10 may select 312 a subset of the plurality of candidate chunks for inclusion in a prompt with the query based upon, at least in part, the amount of non-overlapping content of each candidate chunk. For example, the subset of the plurality of candidate chunks includes a ranked order of chunks for inclusion in the prompt with query 410. As will be discussed in greater detail below, the subset of the plurality of candidate chunks is defined or limited by a performance metric associated with a query.

In some implementations, selecting 312 the subset of the plurality of candidate chunks for inclusion in the prompt includes selecting 322 a first candidate chunk with a highest similarity value compared to the query; and selecting 324 an additional candidate chunk with a highest amount of non-overlapping content relative to remaining candidate chunks of the plurality of chunks. For example, selecting 312 the subset of the plurality of candidate chunk embeddings for inclusion in the prompt includes selecting 322 a first candidate chunk with the highest similarity value compared to the query (i.e., a chunk embedding value with the highest similarity when compared to the query embedding) for inclusion in the prompt. In some implementations, overlapping content selection process 10 selects 324 an additional candidate chunk based upon, at least in part, a highest amount of non-overlapping content relative to the remaining candidate chunks (i.e., the remaining candidate chunks without the first candidate chunk).

In some implementations, selecting 312 the subset of the plurality of candidate chunks for inclusion in the prompt includes selecting further candidate chunk embeddings for inclusion in the subset of the plurality of chunk embeddings until the performance metric associated with the query is reached. A performance metric associated with query 410 is a limitation or threshold specific to the query that determines the number of chunks to be selected for generating the prompt along with the query. For example, the performance metric (e.g., performance metric 420) may be the prompt limit (i.e., the maximum number of tokens for the prompt). In another example, the performance metric may be a lower limit set by overlapping content selection process 10 or the user which defines a “budget”. For example, larger prompts incur a higher cost. The time to generate an answer using LLM decoding is proportional to the prompt size. Also, commercial generative AI models may incur a fee based on the prompt size. For example, the LLM, ChatGPT 3.5, can incur a fee of $0.002 per 1,000 tokens. Accordingly, overlapping content selection process 10 may receive a user-defined performance metric associated with query 410 and/or may use a default performance metric to limit the number of chunks selected for generating the prompt.

Returning again to the example above with query 410 (i.e., “What is the difference between snapshots and replication?”). There are multiple overlapping candidate chunks in document 400 matching query 410. Accordingly, overlapping content selection process 10 evaluates and iteratively selects chunks as shown in Table 2 below:

TABLE 2

| Steps | | Chunk 1 | Chunk 2 | Chunk 3 | Chunk 4 | Chunk 5 |
|---|---|---|---|---|---|---|
| 1 | Chunk Value | .845 | .843 | .829 | .827 | .826 |
| | (Cosine Similarity | | | | | |
| | wrt. Query) | | | | | |
| 2 | Token sort ratio | N/A | .58 | .53 | .29 | .54 |
| | (Chunk1, Chunk | | | | | |
| | K) | | | | | |
| 3 | Chunk Scores | N/A | .354 | .389 | .588 | .38 |
| | after iteration 2 | | | | | |
| 4 | Token sort ratio | N/A | .41 | .16 | N/A | .32 |
| | (Chunk 1 + Chunk | | | | | |
| | 4, Chunk K) | | | | | |
| 5 | Chunk Scores | (1^{st} | .497 | .562 | (2^{nd} | .696 |
| | after iteration 3 | selected) | | | selected) | |

In this example, overlapping content selection process 10 determines the chunk similarity values for chunks 1-5 as noted above. Overlapping content selection process 10 selects 322 a first candidate chunk with a highest similarity value compared to the query. In this example, overlapping content selection process 10 selects 322 chunk 1 with the chunk similarity value of 0.845. Overlapping content selection process 10 selects 324 an additional candidate chunk with a highest amount of non-overlapping content relative to remaining candidate chunks of the plurality of chunks. In this example, overlapping content selection process 10 determines the token sort ratio of chunks 2-5 relative to one another and selects 324 a second candidate chunk (e.g., chunk 2) with the highest amount of non-overlapping content relative to the remaining candidate chunks (e.g., a token sort ratio of 0.58). Assuming that the performance metric associated with the query is not reached, overlapping content selection process 10 determines the token sort ratio of chunks 3-5 relative to one another selects a third candidate chunk (e.g., chunk 5) with the highest amount of non-overlapping content relative to the remaining candidate chunks (e.g., a token sort ratio of 0.588). In this example, suppose that the performance metric associated with the query is met. Accordingly, overlapping content selection process 10 completes the subset of the plurality of candidate chunks with chunks 1, 2, and 5.

In some implementations, overlapping content selection process 10 generates 326 a prompt using the query embedding and the plurality of candidate chunk embeddings. Continuing with the above example, overlapping content selection process 10 generates prompt 422 using chunks 1, 2, and 5. This is shown as action “5”. In some implementations, a generative AI model (e.g., generative AI model 424) is a type of artificial intelligence system that is capable of generating new data samples that are similar to the training data it has been trained with. These models generally work by learning the underlying patterns and structures present in the training data and then using this “knowledge”, they generate new, consistent examples. In some implementations, the generative AI model includes a Large Language Model (LLM). A LLM (e.g., GPT-4 from OpenAI®, OpenLLaMa, and Cerebras-GPT) is a language model consisting of a neural network with many parameters (typically billions of weights or more), trained on large quantities of unlabeled text using self-supervised learning or semi-supervised learning. Though trained on simple tasks along the lines of predicting the next word in a sentence, LLMs with sufficient training and parameter counts capture the syntax and semantics of human language. In some implementations, the generative AI model includes a natural language processing (NLP) model. An NLP model (e.g., XLNet, Robustly Optimized Bidirectional Encoder Representations from Transformers Pretraining Approach (RoBERTa), and Pathways Language Model (PaLM)) is a model that concerns the understanding, analysis, and generation of natural language. NLP models analyze text and speech to extract meaning, as well as generating new text or speech in response.

Many generative AI models, such as LLMs, are not trained on a particular library of input documents used for a particular scenario. As such, these generative AI models lack the context to process content from the particular library of input documents. Accordingly, the process of Retrieval Augmented Generation (RAG) is used to break the relevant input documents into chunks that are small enough to fit prompt size limitations associated with the generative AI model. Overlapping content selection process 10 uses common indexing and retrieval techniques to match user queries to the most relevant content chunks, and then combines the user query and context (one or more chunks) as a prompt to the generative AI model and presents the answer(s) to the user. Returning to the example of FIG. 4. the LLM output (e.g., output 426) is presented to the user. This is shown as action “6”. Returning again to the above example and using the various approaches for identifying candidate chunks selected for the query “What is the difference between snapshots and replication?” are Chunks 1, 2 and 5 (in this order), and the answer provided would be the following:

Answer: The difference between snapshots and replication is:

### Snapshots:

Read-only copies of an object that can be used to save the current state of an object
Can be used to quickly recover data if there is corruption or user error
Cannot be directly accessed by a host
Space efficient copies that share data blocks with their parent object
Can be used to restore a volume or volume group
Can be used to create test environments
Can be used to recover part of a volume, such as individual files or database records
Can be used to create thin clones for development use

### Replication:

Used for planned downtime, such as during inter-cluster migration, the installation of a major software update, and disaster recovery
Provides bi-directional synchronous replication
Can be used for high availability, load balancing, and migration
Can be used for disaster recovery to minimize potential data loss
Can be used for migration between PowerStore systems.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods, and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
generating a plurality of chunks for a plurality of text portions of a document;
generating a plurality of chunk embeddings from the plurality of chunks;
processing a query using a generative artificial intelligence (AI) model;
generating a query embedding from the query;
identifying a plurality of candidate chunks from the plurality of chunks based upon, at least in part, a similarity between the plurality of chunk embeddings and the query embedding;
determining an amount non-overlapping content of each candidate chunk relative to each other candidate chunk; and
selecting a subset of the plurality of candidate chunks for inclusion in a prompt with the query based upon, at least in part, the amount of non-overlapping content of each candidate chunk.

2. The computer-implemented method of claim 1, wherein processing the query includes processing the query during Retrieval Augmented Generation (RAG) using the generative AI model.

3. The computer-implemented method of claim 1, wherein determining the amount of non-overlapping content of each candidate chunk includes determining a cosine-similarity between each candidate chunk relative to each other candidate chunk.

4. The computer-implemented method of claim 1, wherein determining the amount of non-overlapping content of each candidate chunk includes determining a token sort ratio between tokens of each candidate chunk relative to each other candidate chunk.

5. The computer-implemented method of claim 1, wherein determining the amount of non-overlapping content of each candidate chunk includes determining a token set ratio between tokens of each candidate chunk relative to each other candidate chunk.

6. The computer-implemented method of claim 1, wherein selecting the subset of the plurality of candidate chunks for inclusion in the prompt includes:
selecting a first candidate chunk with a highest similarity value compared to the query; and
selecting an additional candidate chunk with a highest amount of non-overlapping content relative to remaining candidate chunks of the plurality of chunks.

7. The computer-implemented method of claim 1, further comprising:
generating the prompt using the query and the subset of the plurality of candidate chunks; and
providing the prompt to the generative AI model.

8. A computer program product residing on a non-transitory computer readable medium having a plurality of instructions stored thereon which, when executed by a processor, cause the processor to perform operations comprising:
generating a plurality of chunks for a plurality of text portions of a document;
generating a plurality of chunk embeddings from the plurality of chunks;
processing a query using a generative artificial intelligence (AI) model;
generating a query embedding from the query;
identifying a plurality of candidate chunks from the plurality of chunks based upon, at least in part, a similarity between the plurality of chunk embeddings and the query embedding;
determining an amount non-overlapping content of each candidate chunk relative to each other candidate chunk; and
selecting a subset of the plurality of candidate chunks for inclusion in a prompt with the query based upon, at least in part, the amount of non-overlapping content of each candidate chunk.

9. The computer program product of claim 8, wherein processing the query includes processing the query during Retrieval Augmented Generation (RAG) using the generative AI model.

10. The computer program product of claim 8, wherein determining the amount of non-overlapping content of each candidate chunk includes determining a cosine-similarity between each candidate chunk relative to each other candidate chunk.

11. The computer program product of claim 8, wherein determining the amount of non-overlapping content of each candidate chunk includes determining a token sort ratio between tokens of each candidate chunk relative to each other candidate chunk.

12. The computer program product of claim 8, wherein determining the amount of non-overlapping content of each candidate chunk includes determining a token set ratio between tokens of each candidate chunk relative to each other candidate chunk.

13. The computer program product of claim 8, wherein selecting the subset of the plurality of candidate chunks for inclusion in the prompt includes:
selecting a first candidate chunk with a highest similarity value compared to the query; and
selecting an additional candidate chunk with a highest amount of non-overlapping content relative to remaining candidate chunks of the plurality of chunks.

14. The computer program product of claim 13, wherein the operations further comprise:
generating the prompt using the query and the subset of the plurality of candidate chunks; and
providing the prompt to the generative AI model.

15. A computing system comprising:
a memory; and
a processor configured to generate a plurality of chunks for a plurality of text portions of a document, to generate a plurality of chunk embeddings from the plurality of chunks, to process a query using a generative artificial intelligence (AI) model, to generate a query embedding from the query, to identify a plurality of candidate chunks from the plurality of chunks based upon, at least in part, a similarity between the plurality of chunk embeddings and the query embedding, to determine an amount non-overlapping content of each candidate chunk relative to each other candidate chunk, and to select a subset of the plurality of candidate chunks for inclusion in a prompt with the query based upon, at least in part, the amount of non-overlapping content of each candidate chunk.

16. The computing system of claim 15, wherein processing the query includes processing the query during Retrieval Augmented Generation (RAG) using the generative AI model.

17. The computing system of claim 15, wherein determining the amount of non-overlapping content of each candidate chunk includes determining a cosine-similarity between each candidate chunk relative to each other candidate chunk.

18. The computing system of claim 15, wherein determining the amount of non-overlapping content of each candidate chunk includes determining a token sort ratio between tokens of each candidate chunk relative to each other candidate chunk.

19. The computing system of claim 15, wherein determining the amount of non-overlapping content of each candidate chunk includes determining a token set ratio between tokens of each candidate chunk relative to each other candidate chunk.

20. The computing system of claim 15, wherein selecting the subset of the plurality of candidate chunks for inclusion in the prompt includes:
selecting a first candidate chunk with a highest similarity value compared to the query; and
selecting an additional candidate chunk with a highest amount of non-overlapping content relative to remaining candidate chunks of the plurality of chunks.
